(19) United States
(12) Patent Application Publication
(10) Pub. No.: US 2005/0178504 A1
(43) Pub. Date: Aug. 18, 2005

(54) Apparatus and method for treating disc-shaped substrates

(76) Inventors: Ulrich Speh, STEINENBRONN (DE); Eberhard Nagele, Schoenaich (DE)

Correspondence Address: Robert W Becker & Associates, Suite B, 707 Highway 66 East, Tijeras, NM, 87059, US

(21) Appl. No.: 10/501,256

(22) PCT Filed: Dec. 20, 2002
(86) PCT No.: PCT/EP02/14632

(30) Foreign Application Priority Data
Jan. 9, 2002 (DE) 102 00 525.7

(51) Int. Cl. B44C 1/22; C23F 1/00

(52) U.S. Cl. 156/345.21; 216/83

(57) ABSTRACT

In order to carry out simple, low-cost, uniform treatment of substrates, a device is provided for the processing of disk-shaped substrates, especially semiconductor wafers, comprising a substantially flat carrier ring, which can be rotated on a plane about an axis of rotation by means of a rotation device, and at least three support elements extending from the plane of the carrier ring, forming a multi-point support for the support at a distance from the plane of the carrier ring. The invention also relates to a device and a method for the treatment of disk-shaped substrates, especially semiconductor wafers, wherein the substrates are rotated about an axis of rotation which is disposed in a substantially vertical position with respect to the plane of the substrates and whereby at least one first group of nozzles are disposed at various distances from the axis of rotation, enabling a first fluid to be applied, said nozzles being controlled either individually or in sub-groups, in order to carry out selective treatment of surface areas of the substrate.

The present invention relates to an apparatus and a method for the treatment of disc-shaped substrates.

In the semiconductor industry, it is known to treat semiconductor wafers with fluids, especially liquids, between various manufacturing steps. This frequently involves a cleaning of the wafers. From DE-A-19830162, which originates with the same applicant, for example a cleaning apparatus is known that is used after a CMP treatment (chemical mechanical polishing) of the wafers. With the known apparatus, after the CMP treatment, the wafers are initially somewhat pre-cleaned with a brush cleaner. Subsequently, the wafers are collected in a liquid-filled tank in order subsequently to be cleaned together as a charge in a finish cleaning apparatus.

This apparatus has the drawback that prior to their finish cleaning, the wafers must be respectively collected to form a charge, as a result of which the continuous treating process of the wafers, and hence the throughput of a manufacturing unit, are adversely affected. Furthermore, the connection of the cleaning apparatus in a CMP unit, as well as in other units, which generally operate in the single wafer process, is difficult.

An apparatus and a method for the treatment of individual semiconductor wafers with a treatment liquid are known from WO-A 99/16109. With the known apparatus and method, a semiconductor wafer is accommodated in the interior, i.e. in the plane, of a rotatable carrier ring and is rotated about an axis of rotation that extends perpendicular to the substrate. During a rotation, a treatment fluid is supplied to the substrate via a first plurality of nozzles. Due to the rotation of the substrate, and the centrifugal force that is produced thereby, the liquid flows outwardly. The first plurality of nozzles is disposed on a carrier that is movable radially relative to the axis of rotation, so that the nozzles are movable radially relative to the axis of rotation. Provided on the carrier is a further nozzle via which a heated gas can be conducted onto the substrate. The heated gas has the function of reducing the surface tension of the liquid at the liquid-gas-interface, as a result of which a good drying of the substrate should be achieved. During the drying of the substrate, the carrier that carries the nozzles is moved radially away from the axis of rotation, to achieve a drying of the substrate from the inside toward the outside.

With the known apparatus there results on the one hand the problem that the handling device cannot readily engage the substrate that is accommodated in the carrier ring since the substrate is accommodated in the plane of the carrier ring. Furthermore, due to the accommodation of the substrate in the plane of the carrier ring there exists the danger that due to the centrifugal force outwardly flung liquid strikes or appears on the carrier ring and is sprayed back in the direction of the substrate, which can adversely affect a uniform treatment of a substrate. In addition, there is the problem that for the carrier that carries the nozzles, a movement mechanism must be provided that can introduce contaminations into the treatment space. Furthermore, within the treatment space, adequate space must be provided for the movement of the carrier, as a consequence of which the apparatus requires a large amount of space.

Proceeding from the known state of the art, it is therefore an object of the present invention to provide an apparatus and a method for the treatment of disc-shaped substrates that in a straightforward and economical manner enable a uniform treatment of individual substrates.

Pursuant to the invention, this object is realized with an apparatus for the treatment of disc-shaped substrates, in particular semiconductor wafers, having an essentially planar carrier ring that is rotatable about an axis of rotation via a rotation device in the plane, in that at least three support elements are provided that extend out of the plane of the carrier ring and that form a multi-point support for the substrate at a distance from the plane of the carrier ring. By providing a multi-point support that is spaced from the plane of the carrier ring, the danger is eliminated that treatment fluid that is flung off from the surface of the substrate strikes the carrier ring and is sprayed back onto the substrate. Furthermore, it is possible for a handling device to enter between the carrier ring and the multi-point support in order to raise the substrate from the multi-point support or to place it thereupon. Therefore, the handling device for the loading and unloading of the carrier ring can be significantly simplified.

Support surfaces of the support elements are advantageously disposed upon a peripheral contour of the substrate in order to essentially contact only the edge region of the substrate. This enables a simultaneous and uniform treatment of both surfaces of the substrate. To enable a uniform treatment of both surfaces of the substrate, the support elements preferably extend into the region of the central opening of the carrier ring. Both surfaces of the substrate are thus essentially freely accessible. In this connection, the support elements preferably extend from the inner periphery of the carrier ring. The support elements preferably extend at an incline to the plane of the carrier ring in order in a simple manner to enable an arrangement of the substrate in the region of the central opening of the carrier ring. Furthermore, due to the inclined arrangement the support elements the substrate is overlapped as little as possible.

Pursuant to a preferred embodiment of the invention, the support surfaces of the support elements are inclined relative to the plane of the carrier ring in order to enable a self-centering of a substrate disposed thereon. Furthermore, due to the inclined support surface only a peripheral edge of the substrate rests upon the support surfaces, and a treatment fluid that is applied to the substrate can reach all regions of the supported surface of the substrate.

The apparatus preferably has at least two abutment or stop surfaces, which extend essentially perpendicular to the plane of the carrier ring, for limiting a lateral movement of the substrate. This prevents the substrate from moving laterally during the rotation of the carrier ring and possibly becoming damaged as a result thereof. Pursuant to one embodiment of the invention, the stop surfaces are formed on the support elements, which prevents a lateral movement of the substrate in a particularly straightforward and economical manner.

Pursuant to an alternative embodiment, the stop surfaces are provided on abutment elements that are separately provided from the support elements and that are preferably movably disposed on the carrier ring and are movable between a free position and a position that contacts the substrate. This makes it possible to first deposit the substrates upon the support elements and to subsequently provide a lateral fixation for the substrate. This makes it in particular possible to accommodate substrates having different diameters, since a lateral fixation is effected by the movable stop elements.

The abutment elements are preferably movable into contact with the substrate via a rotational movement of the carrier ring, thereby avoiding an additional drive mechanism for the abutment elements. To enable a good flowing-off of a fluid that is found on the rotating substrate, the abutment elements preferably have a cross-section that widens in an essentially V-shaped manner from the stop surfaces.

Pursuant to a particularly preferred embodiment of the invention, the carrier ring, and the rotation device that it is associated therewith, are disposed between the support surfaces of the support elements to prevent contaminations, especially abraded material, that is generated by the rotation device from reaching the treated substrates.

The object that is the basis of the invention is also realized by an apparatus for the treatment of disc-shaped substrates, especially semiconductor wafers, and having a device for the rotation of the substrates about an axis of rotation, and having at least one first group of nozzles, where the nozzles are differently spaced relative to the axis of rotation, in that the nozzles can be controlled individually or in sub groups. As a consequence of the control of the nozzles individually or in sub groups, it is possible to achieve a selective treatment of surface regions of the substrate, especially edge regions of the substrate.

The apparatus preferably has at least one further group of nozzles, according to which the nozzles are differently spaced relative to the axis of rotation, and whereby the nozzles of the second group are preferably again controllable individually or in sub groups. The second group of nozzles enables the simultaneous and/or subsequent application of a further fluid, whereby the individual control enables a controlled displacement of a fluid applied by the first nozzles via a further fluid. In this connection, three groups are preferably provided in order to conduct onto the substrate, for example, a treatment fluid, a cleaning fluid, a rinsing fluid and/or a drying fluid, without that the different fluids have to be applied via common nozzles. This prevents a mixing together of the various fluids in the region of the supply lines and/or of the nozzles.

Pursuant to a preferred embodiment of the invention, the nozzles of at least one further group are disposed in the region of the spacing of the nozzles of the first group relative to the axis of rotation. In combination with the rotational movement of the substrate, this enables the production of different concentric application regions or zones for each of the nozzles, whereby the application regions of the nozzles of one group respectively alternate with the application regions of the nozzles of the other group. This enables a controlled displacement of a fluid, applied by the nozzles of one group, by a fluid applied by the other group.

The nozzles of at least one group are preferably disposed upon a straight line that extends radially relative to the axis of rotation; this leads to a straightforward construction of the apparatus, and in particular of the supply lines for the nozzles. For a compact construction of the apparatus, the nozzles of the first group and of at least one further group are preferably disposed upon a straight line that extends radially relative to the axis of rotation. In this connection, the nozzles of the first group preferably alternate with the nozzles of the second group upon the straight line.

The nozzles of at least one group can preferably be supplied with fluid via a common fluid supply unit, which ensures that the nozzles of one group can be controlled with the same fluid and with essentially the same pressure. In this connection, the nozzles of at least one group can preferably be supplied with fluid via a common pressure line.

Pursuant to an alternative embodiment of the invention, the nozzles of at least one group can be supplied with different fluids, as a result of which even with a single group of nozzles it is possible to treat the substrate with different fluids. To enable the application of a fluid in specific regions of the substrate, the nozzles of at least one group can be activated and/or deactivated individually or in sub groups, thus enabling, for example, an exclusive treatment of the edge region. Furthermore, this enables a controlled displacement of a fluid by a further fluid. To obtain good treatment results, the shape of the nozzle stream or spray and/or the flow volume of at least one nozzle of at least one group can be varied.

Pursuant to a particularly preferred embodiment of the invention, one nozzle is disposed on or in the region of the axis of rotation in order to enable an application of a fluid upon the substrate in the region of the axis of rotation to ensure a complete treatment of the substrate. The nozzle can be associated with one or more of the groups of nozzles, or it can also be embodied as a single, independent nozzle. The nozzle can preferably be supplied with different fluids in order to enable a uniform treatment of the substrate with different fluids proceeding from the axis of rotation. In this connection, at least two separate supply lines for different fluids are provided to avoid, at least in the region of the supply lines, a mixing together of the different fluids.

To enable a simultaneous treatment of the upper and lower sides of a disc-shaped substrate, at least one group of nozzles is provided above and below the substrate.

Pursuant to a particularly preferred embodiment of the invention, the inventive carrier ring is used in combination with the inventive nozzle arrangement, since due to the combination, along with a compact manner of construction, it is possible to achieve a particularly uniform treatment of both surfaces of a disc-shaped substrate.

The object that is the basis of the invention is also realized with a method for the treatment of disc-shaped substrates, especially semiconductor wafers, according to which the substrates are rotated about an axis of rotation that is disposed essentially perpendicular to the plane of the substrates, and a first fluid is applied via at least one first group of nozzles, which are differently spaced relative to the axis of rotation, in that the nozzles are controlled individually or in sub groups to enable a selective treatment of surface regions of the substrate. Due to the individual or group control of these nozzles, selective surface regions of the substrate can be treated without having to move the nozzles, thereby reducing the danger of a contamination of a treatment space and/or of the substrates. Furthermore, the treatment space can have a compact configuration since the nozzles are stationary.

To terminate the treatment of the substrate with the first fluid, at least one further fluid is conducted onto the substrate via at least one nozzle, as a result of which the first fluid is displaced from the substrate. In this connection, the further fluid is conducted onto the substrate via at least one nozzle of at least one further group of nozzles in order to prevent a mixing together of the fluids in the supply lines to the nozzles or on the nozzles. Furthermore, this enables a controlled displacement of the first fluid.

To ensure a controlled and uniform displacement of the first fluid, the further fluid is preferably applied via a nozzle that is disposed closer to the axis of rotation than is a nozzle via which the first fluid is applied to the substrate. As a result, due to the rotation the centrifugal force that is produced achieves a displacement of the first fluid in a radially outward direction.

Pursuant to a particularly preferred embodiment of the invention, upon termination of the treatment with the first fluid, the nozzles that apply the first fluid are sequentially deactivated in a direction away from the axis of rotation, or are switched to the application of the second fluid. In this way, a uniform and controlled termination of the treatment is achieved. In order in this connection to provide an appropriate uniform displacement of the first fluid, the nozzles that apply the further fluid are preferably sequentially activated in a direction away from the axis of rotation in order to apply the further fluid upon the substrate in a radially increasing region, and to displace the first fluid in a controlled manner. To start with, the further fluid is preferably applied to the substrate in the region of the axis of rotation in order to ensure a complete displacement of the first fluid.

Pursuant to a further embodiment of the invention, the treatment with the further fluid is terminated by applying a further fluid in the same manner as the treatment with the first fluid was terminated.

The first fluid is preferably a cleaning or rinsing liquid. Preferably, at least one further fluid is a rinsing liquid and/or a fluid that reduces the surface tension of the fluid found on the substrate, in order to achieve a uniform rinsing and/or drying of the substrate.

A simultaneous treatment of the upper and lower sides of the substrate is preferably effected.

The invention will subsequently be explained in greater detail with the aid of preferred embodiments of the invention with reference to the drawings.

The drawings show:

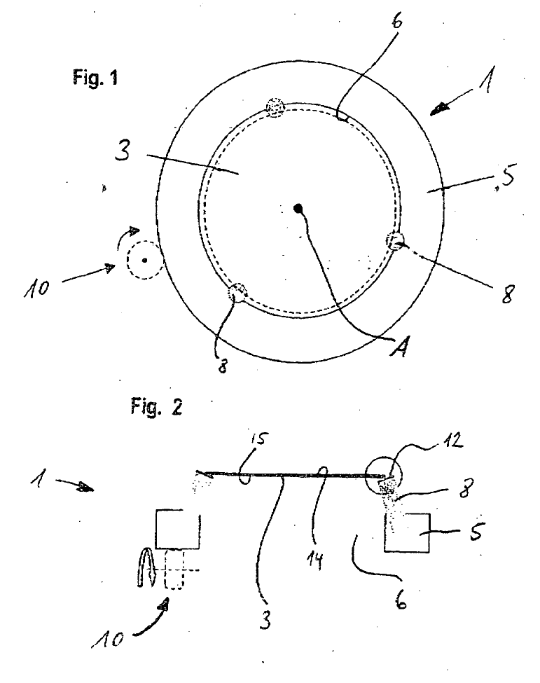

FIG. 1 a schematic plan view upon a carrier ring having a drive pursuant to the present invention;

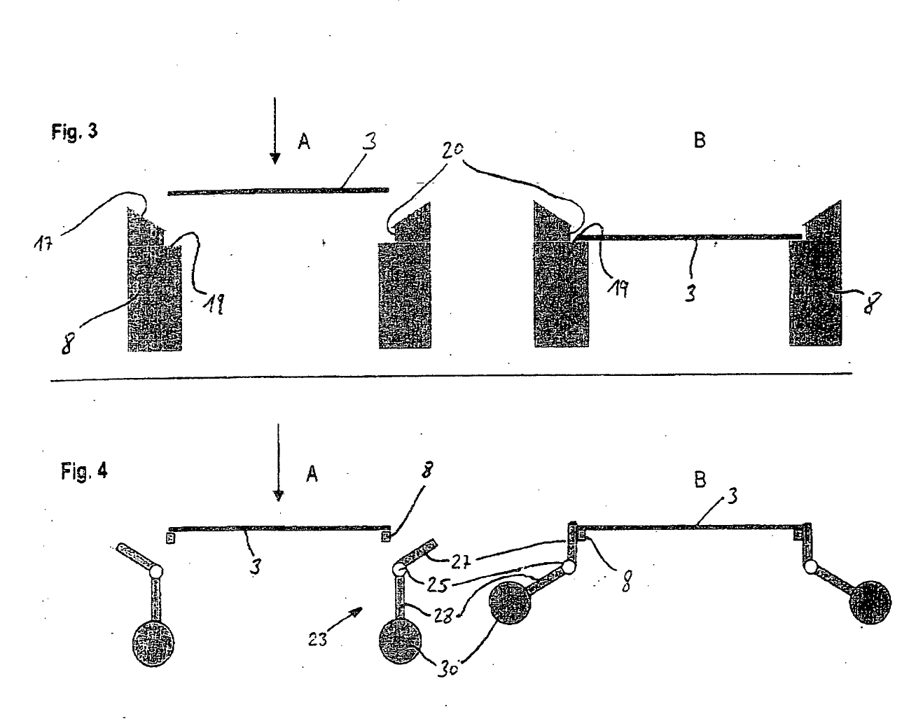

FIG. 2 a schematic sectional view of a carrier ring having a drive pursuant to an alternative embodiment of the invention;

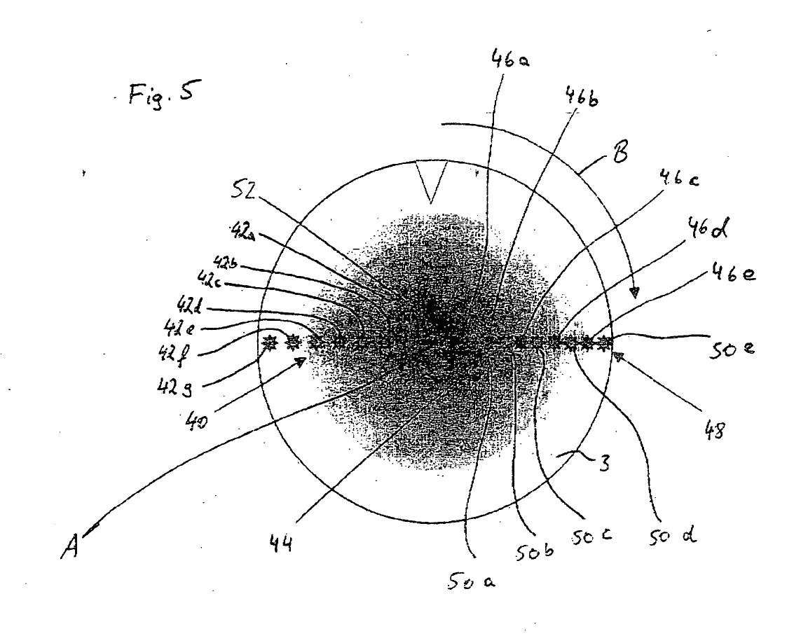

FIGS. 3A and 3B holding pins pursuant to an embodiment of the invention;

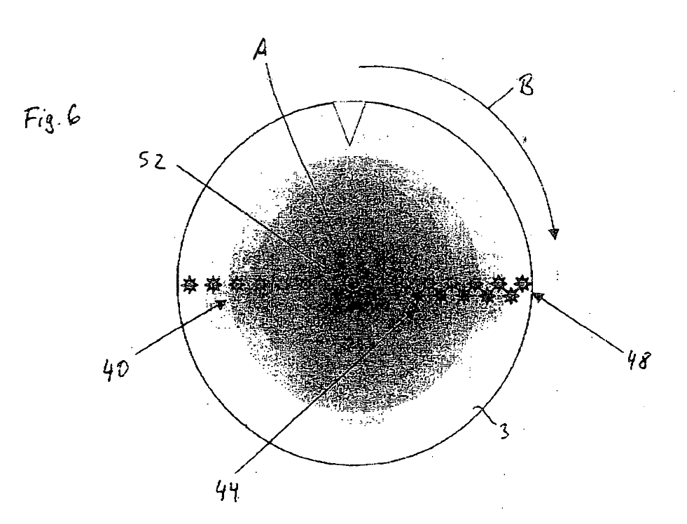

FIGS. 4A and 4B movable abutment elements pursuant to an embodiment of the present invention;

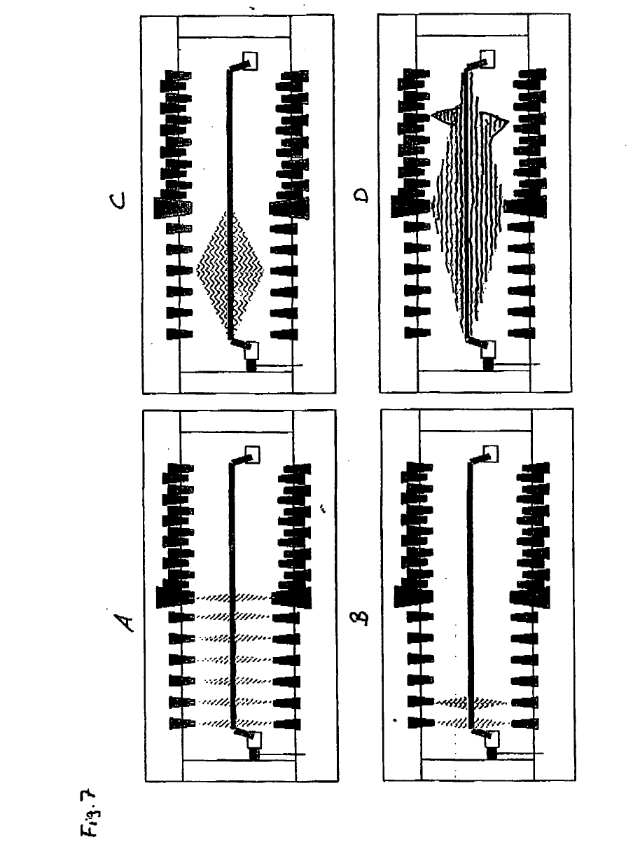

FIG. 5 a nozzle arrangement for the treatment of the disc-shaped substrate pursuant to a first embodiment of the invention;

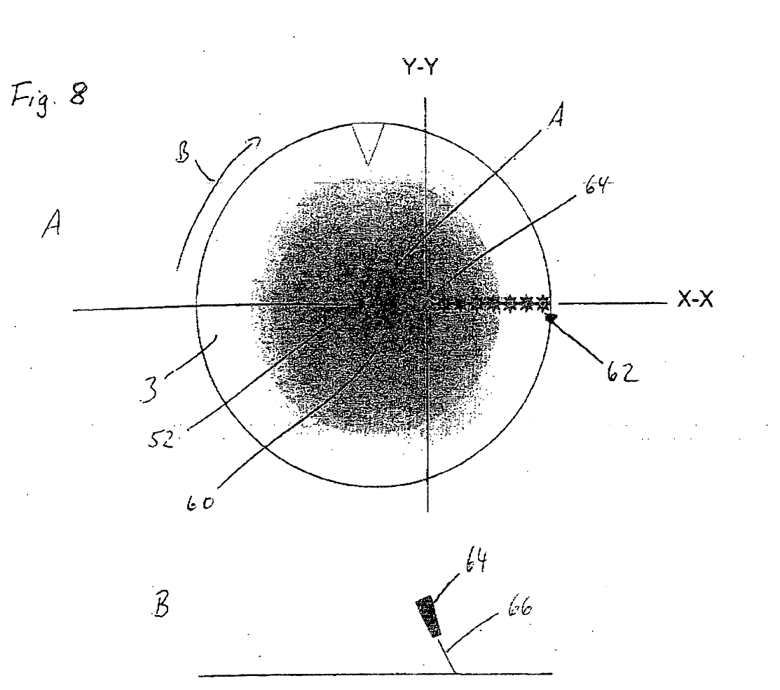

FIG. 6 a nozzle arrangement for the treatment of a disc-shaped substrate pursuant to an alternative embodiment of the present invention;

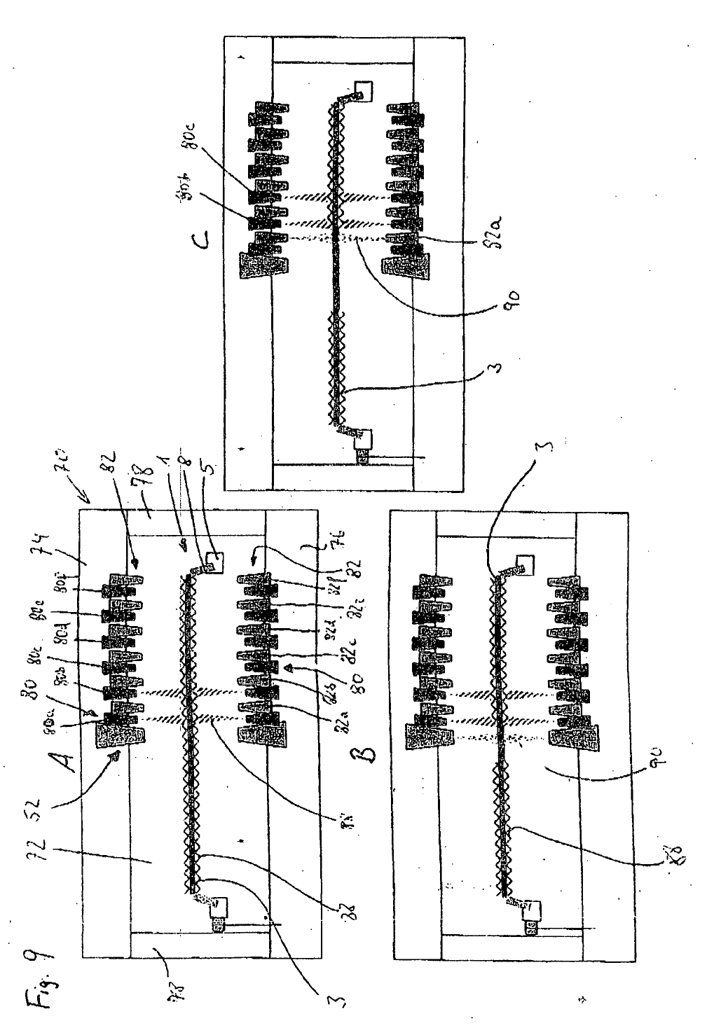

FIGS. 7A to 7D schematic sectional views through a cleaning apparatus of the present invention during different treatment steps;

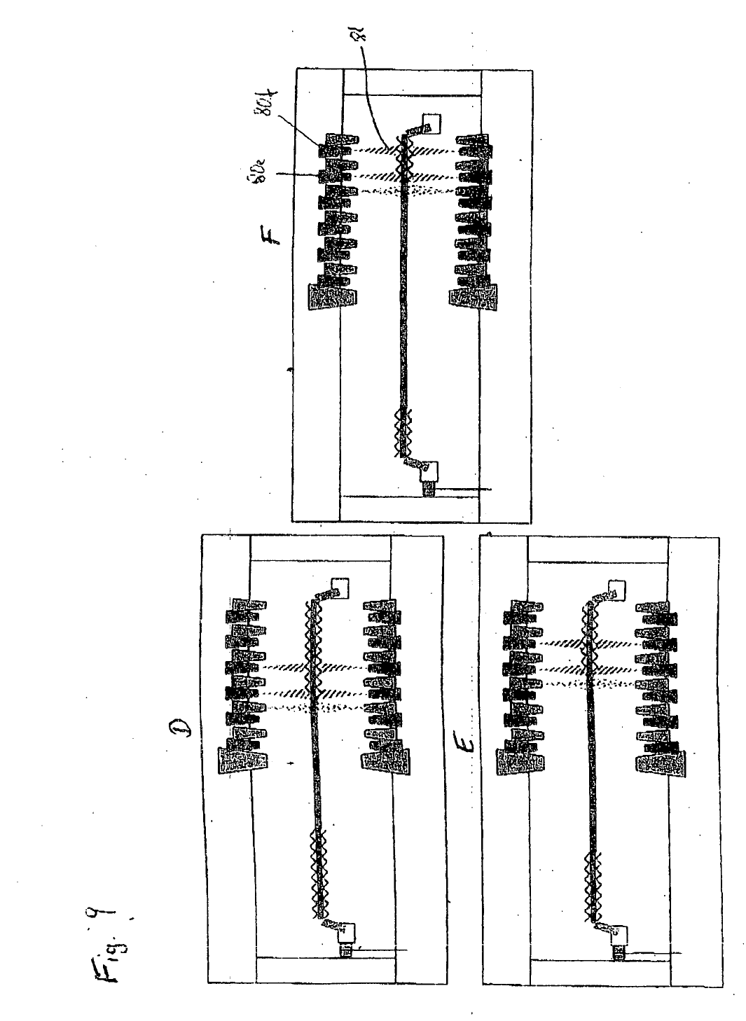

FIGS. 8A and 8B a schematic plan view upon a nozzle arrangement pursuant to a further embodiment of the invention, as well as a schematic sectional view through an individual nozzle along the line X-X in FIG. 8A;

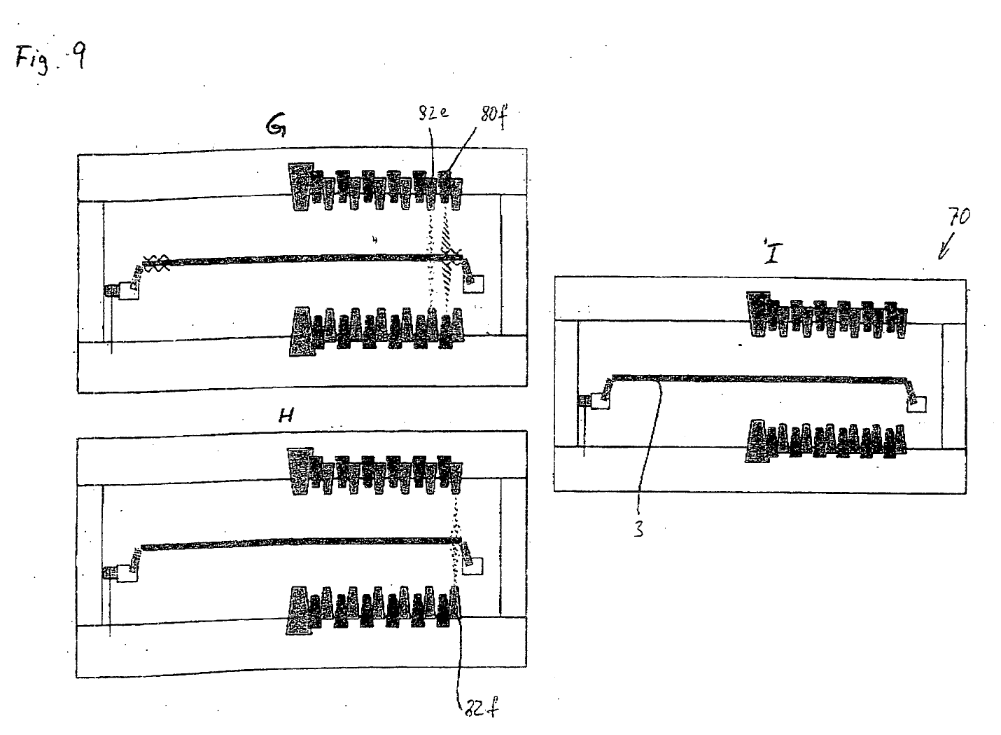

FIGS. 9A to 9I schematic sectional views through a cleaning apparatus pursuant to the present invention during different steps during a wafer drying;

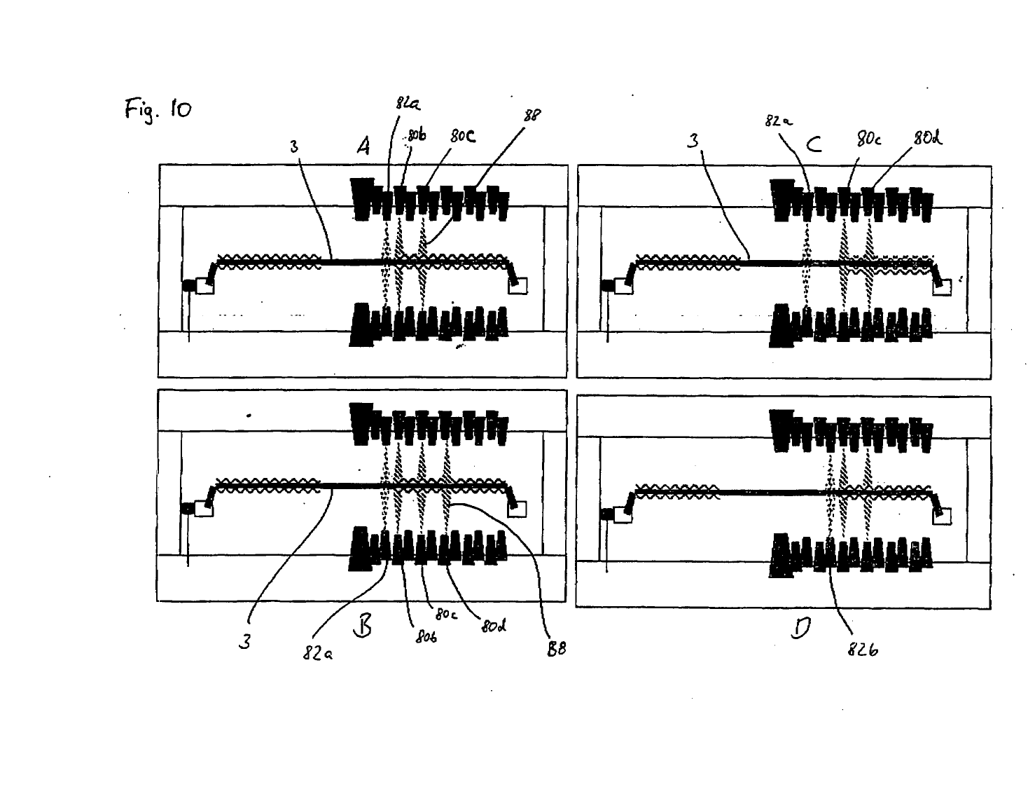

FIGS. 10A to 10D a sectional view similar to FIG. 9 which shows intermediate steps between FIGS. 9C and 9D.

FIG. 1 shows a plan view of an inventive substrate carrier 1 for holding disc-shaped semiconductor wafers 3 in an apparatus for the treatment of semiconductor wafers. The substrate carrier 1 is provided with a planar carrier ring 5 having an inner opening 6. In this connection, the circumference of the opening 6 is greater than an outer circumference of the substrate 3.

The substrate carrier 1 is furthermore provided with three support elements 8 that are stationarily secured to the carrier ring 5 and are in the form of support pins. The support elements 8 extend into the region of the central opening 6 in order to form, in this region, a three-point support for the substrates. Relative to the planar carrier ring 5, the support elements 8 extend upwardly in order to dispose the three-point support, relative to the carrier ring 5, in a plane that is spaced in a direction perpendicular to the plane of the carrier ring 5.

Furthermore provided in FIG. 1 is a rotational drive device 10 for rotating the carrier ring 5 about an axis of rotation A that extends perpendicular to the carrier ring 5. With the embodiment illustrated in FIG. 1, the rotational drive 10 laterally, i.e. radially, engages the carrier ring 5. A suitable mounting device that is not illustrated in detail can be provided for rotatably holding the carrier ring 5.

FIG. 2 shows an alternative embodiment of a substrate carrier 1, whereby the same reference numerals are used in FIG. 2 to the extent that they designate the same or similar elements.

The substrate carrier 1 of FIG. 2 is again provided with a planar carrier ring 5 having an inner opening 6 that is essentially greater than the outer circumference of the substrates that are to be accommodated. Again provided on the carrier ring 5 are support elements 8 that form a multi-point support that is spaced above the carrier ring 5. With the embodiment illustrated in FIG. 2, the support elements 8 extend not only at an incline to the axis of rotation A, but also to the plane of the carrier ring 5 in order to dispose the multi-point support above the carrier ring 5 and in the region of the central opening 6. A rotational drive 10 is again provided for the carrier ring 5 and in the embodiment illustrated in FIG. 2 engages an underside of the carrier ring 5. Again, non-illustrated mounting elements are provided for rotatably holding the carrier ring 5. The mounting elements preferably hold the carrier ring 5 in an essentially horizontal orientation in an apparatus for the treatment of semiconductor wafers, as will be described in greater detail subsequently.

As can be seen in FIG. 2, the support elements 8 form a support surface 12 that is inclined relative to the horizontal and that on the one hand can provide a centering of the semiconductor wafer 3 and on the other hand enables as free an access as possible to all regions of an upper side 14 as well as an underside 15 of the semiconductor wafer 3. The free access to the underside 15 is made possible in that the semiconductor wafer 3 essentially rests exclusively on the inclined support surface 12 of the support pin 8 via a lower peripheral edge.

FIG. 3 shows an alternative embodiment of a support element 8 that can be secured to a carrier element 5. In FIG. 3 the same reference numerals are used to the extent that the same or similar elements are indicated.

In FIG. 3, two support elements 8 are illustrated, whereby in FIG. 3A the provision of a semiconductor wafer 3 is illustrated, while in FIG. 3B the semiconductor wafer 3 rests upon the support elements 8. The holding or support elements 8 can be disposed on the carrier ring 5 in a perpendicular manner or, as illustrated in FIG. 2, at an incline to the axis of rotation A. The support elements 8 are provided with inclined centering surfaces 17 along which a semiconductor wafer 3 disposed thereon can slide in order subsequently to be placed in a centered manner upon essentially horizontally extending support shoulders 19. With this embodiment of the support element 8, the edge overlap between the support element 8 and the semiconductor wafer 3 is kept as small as possible, and lies, for example, in a range of 0.5-1.5 mm, preferably in the vicinity of 1 mm. The support elements 8 are furthermore provided with abutment or stop surfaces 20 that limit a lateral movement of the semiconductor wafer when this wafer rests upon the support shoulders 19, as shown in FIG. 3B. The stop surfaces 20 have as small a surface as possible in order, during a rotation of the semiconductor wafer 3, to prevent liquid that strikes the stop surfaces from spraying back in a direction toward the semiconductor wafer 3. To enable a good running-off of liquids in a radial direction, the stop surface 20 forms the apex of a cross-section of the support element 8 that in this region widens away from the stop-surface 20.

FIG. 4 shows an alternative device for limiting the lateral movement of the semiconductor wafer 3 during a rotation of the carrier ring 5. For simplification of the illustration, the support elements 8 are illustrated only schematically as supports. Furthermore, the carrier ring 5 is also not illustrated in FIG. 4. However, in addition to the only schematically indicated support elements 8, pivotable retention devices are provided on the carrier ring 5. In FIG. 4, two retention devices are illustrated, whereby, however, preferably three or any desired other number can be provided. Each of the retention devices 23 is provided with a pivot bearing 25, a limit or stop element 27, a lever arm 28, as well as a weight 30. The pivot bearing 25 is disposed on the carrier ring 5 in a suitable manner in order to enable a pivoting of the limit element 27 in the direction of the axis of rotation A of the carrier ring 5. FIG. 4A shows the position of the limit element 23 during a rest position in which the carrier ring 5 does not rotate about the axis of rotation A. FIG. 4B shows the position of the limit elements 23 during a rotation of the carrier ring 5 about the axis of rotation A. As a consequence of the centrifugal force that results during the rotation, the weight 30 is pressed outwardly, as a result of which the stop element 27 is moved in the direction of the axis of rotation A. In so doing, the stop element 27 comes into contact with an outer periphery of the semiconductor wafer 3 that rests upon the support elements 8 and prevents a lateral movement of the wafer. This use of a stop that is controlled by centrifugal force is particularly advantageous in conjunction with inclined support surfaces of the support elements 8, as shown by way of example in FIG. 2, since the inclined support surfaces provide only a limited lateral retention force for the semiconductor wafers 3.

The different features of individual elements of the substrate carriers 1 described above can be freely combined or exchanged to the extent that they are compatible.

FIG. 5 shows a schematic plan view of a nozzle arrangement for an apparatus for the treatment of disc-shaped substrates pursuant to the present invention. In FIG. 5, a semiconductor wafer 3 is shown as the substrate that is to be treated and that is rotated about an axis of rotation A via a suitable device, such as, for example, the carrier ring 1 described in FIGS. 1 to 4, with such rotation being indicated by the arrow B.

The nozzle arrangement illustrated in FIG. 5 is provided with a first group 40 of nozzles 42a to 42g. The nozzles 42a to 42g of the first group of nozzles 40 extend along a straight line that is disposed radially relative to the axis of rotation A. In this connection, the nozzles 42a to 42g are disposed at different distances relative to the axis of rotation A, whereby the nozzle 42a is the closest to the axis of rotation A and the nozzle 42g is disposed the furthest from the axis of rotation.

It is to be understood, of course, that depending upon the size of the semiconductor wafer 3 that is to be treated, or depending upon other requirements of the treatment apparatus, a different number of nozzles can be selected for the first group of nozzles 40. It is also not necessary that the nozzles 40 be disposed along a common straight line.

By means of a non-illustrated common conduit, the nozzles 42a to 42g are in communication with a non-illustrated common fluid supply. Due to the rotation of the semiconductor wafer 3, the nozzles 42a to 42g can therefore apply a fluid to the wafer 3 along different rings that extend concentrically about the axis of rotation A. It is thereby possible, via the common fluid supply, to successively make available different fluids, such as, for example, a cleaning and a rinsing fluid and/or fluid mixtures. It is, of course, also possible for each of the nozzles 42a to 42g to be connected via individual conduits with a common fluid supply or with respectively individual fluid supplies. It is also possible to divide the nozzles 42a to 42g of the first group 40 of nozzles into subgroups, and to respectively connect the nozzles of the subgroups with a common conduit or a common fluid supply.

The nozzles 42a to 42g can be respectively controlled individually or in subgroups. For example, the nozzles can be selectively activated or deactivated individually or in subgroups. In addition, or alternatively, it is possible to control the flow volume through each individual nozzle or nozzle subgroup and/or the opening or spray angle of a nozzle or of the nozzles of a subgroup. By means of a flow volume, it is possible, for example, to establish concentration differences upon the wafer surface. By means of the opening or spray angle, it is possible to establish different spray shapes, such as, for example, a (complete) conical spray, a fan-shaped spray, or a point spray, in order to fulfill defined process requirements. A non-illustrated control unit is provided for the control of the nozzles.

The nozzle arrangement pursuant to FIG. 5 is provided with a second nozzle group 44 having nozzles 46a to 46e. The nozzles 46a to 46e of the second nozzle group 44 are disposed along the same straight line as are the nozzles 42a to 42g of the first group 40 of nozzles, although on an opposite side relative to the axis of rotation A. The nozzles 46a to 46e are again disposed at different distances relative to the axis of rotation A, whereby the nozzles 46a is located the closest to the axis of rotation A, and the nozzle 46e is disposed the furthest therefrom. In combination with the rotational movement of the wafer 3, by means of the second nozzle group 44 a fluid can be applied to the wafer 3 in concentric rings, whereby the fluid is, for example, a rinsing liquid such as DI water.

The nozzles 46a to 46e of the second nozzle group are connected with a fluid supply in a manner similar to that of the nozzles of the first nozzle group 40. Furthermore, each of the nozzles of the second nozzle group can be controlled individually or in subgroups, and in particular in the same way as the nozzles of the first nozzle group 40.

The nozzle arrangement of FIG. 5 is additionally provided with a third nozzle group 48 having nozzles 50a to 50e. The nozzles 50a to 50e are disposed along the same straight line as are the nozzles 46a to 46e of the second nozzle group 44, whereby the nozzles of the first and second nozzle group 44, 48 alternate along the straight line.

By means of the nozzles of the third nozzle group 48 a fluid, in particular a drying fluid, can again be applied to the wafer 3. The drying fluid is, in particular, a fluid, such as, for example, IPA (Isopropyl Alcohol), that reduces the surface tension of a fluid disposed upon the wafer. In the same way as the nozzles of the first and second nozzle groups 40, 44, the nozzles 50a to 50e of the third nozzle group 48 are connected with a fluid supply. Furthermore, the nozzles 50a to 50e of the third nozzle group 48 can be controlled individually or in subgroups in a similar manner to the nozzles of the first or second nozzle groups 40, 44.

The nozzle arrangement of FIG. 5 is furthermore provided with a central nozzle 52 that is disposed on the axis of rotation A. By means of the central nozzle 52, different fluids, in particular the fluids that can be applied by the three nozzle groups 40, 44, 48, can be applied to the wafer. The central nozzle is provided with supply lines for the different fluids in order to prevent a mixing of the fluids in the supply lines. If a mixing of fluids is not detrimental, different fluids can also be conducted to the central nozzle 52 via a common feed line. Although the nozzle group illustrated in FIG. 5 was described as being disposed above the wafer 3, the nozzle arrangement can in the same way also be disposed below a wafer 3. It is to be understood, of course, that appropriate nozzle groups can also be disposed above and below the wafer 3 in order to permit a simultaneous treatment of the opposite surfaces of the wafer 3. The nozzles of the respective groups, as well as the central nozzle, can be movable along the axis of rotation in order to set the spacing relative to the substrate. In this connection, the nozzles can be moved individually, in groups or together.

In the following, the operation of the treatment apparatus of FIG. 5 will be briefly described. The wafer 3 is first rotated about the axis of rotation A, via a device that is not illustrated in greater detail, as indicated by the arrow B. Subsequently, via the central nozzle 52 as well as the first nozzle group 40, a treatment fluid, such as a treatment liquid, is applied to the rotating wafer. The treatment liquid is applied to the wafer 3 in concentrically extending annular regions. As a consequence of the centrifugal force that results during the rotation, the liquid flows away outwardly and is flung outwardly from the wafer surface. After a prescribed treatment time, first the central nozzle 52 is changed over to a rinsing liquid, i.e. instead of a treatment liquid now a rinsing liquid is conveyed to the wafer 3 via the central nozzle 52. In the region of the central nozzle 5, the rinsing liquid displaces the treatment liquid that is found on the wafer. Successively, the nozzles 42a to 42g are now changed over in order to achieve the uniform displacement of the treatment liquid. Alternatively, it is also possible to sequentially change over the nozzles 42a to 42g from the introduction of a treatment liquid to the introduction of a rinsing liquid in order to achieve a uniform displacement of the treatment liquid from the inside toward the outside. Additionally or alternatively, rinsing liquid is additionally conveyed to the wafer via the nozzles of the second or third nozzle groups 44, 48, whereby the nozzles are respectively sequentially activated from the inside toward the outside, and in particular in conformity with the deactivation of the nozzles 42a to 42g of the first nozzle group. As a result there is achieved that the nozzle via which rinsing liquid is introduced lies closer to the axis of rotation A than the most inwardly disposed nozzle of the first nozzle group via which a treatment liquid is conveyed to the wafer. This enables a good and uniform displacement of the treatment liquid toward the outside.

After the treatment liquid is completely displaced, and the wafer 3 is adequately rinsed, a drying fluid is now conveyed to the surface of the wafer 3 via the central nozzle 52. The drying fluid is, for example, an PA/nitrogen mixture (IPA=Isopropyl Alcohol) that reduces the surface tension of the rinsing fluid disposed upon the wafer at a boundary surface or interface therebetween, and thus permits a good drying of the wafer. The drying effect proceeds from the axis of rotation A and widens radially outwardly. The nozzles that introduce the rinsing fluid are deactivated in a direction away from the axis of rotation, i.e. from the inside toward the outside. As an example, it is assumed that rinsing fluid is introduced upon the surfaces of the wafer 3 via the second nozzle group 44, i.e. initially first the nozzle 46 is deactivated and subsequently the nozzle 46b, etc. After the nozzle 46a is deactivated, drying fluid is introduced, for example via a nozzle, such as the nozzle 50a, that is disposed inwardly relative to the nozzle 46b, in order to enhance a uniform, radially widening drying of the wafer.

The foregoing operating sequence represents only one of many possible operating sequences, since the respective nozzles of the individual nozzle groups 40, 44, 48 can respectively be individually controlled. It is therefore, for example, not necessary during a cleaning of the wafer to use all of the nozzles of the first nozzle group, as shown by way of example in FIG. 7A. For a selective edge cleaning, for example, it is possible to use only the outer nozzles, as illustrated in FIG. 7B. Furthermore, a surface cleaning via a single one of the nozzles of the first nozzle group 40 is also conceivable by varying the opening spray angle of the nozzle, as indicated in FIG. 7C. It is also possible, for example, for the central nozzle alone to apply a fluid, such as a rinsing fluid, over essentially the entire surface of the wafer 3, as indicated by way of example in FIG. 7D.

FIG. 6 shows an alternative embodiment of an inventive nozzle arrangement. With the description of FIG. 6, the same reference numerals are used as in FIG. 5 to the extent that similar or identical elements are indicated. FIG. 6 shows a semiconductor wafer 3 that is rotatable about an axis of rotation A as indicated by the arrow B. The nozzle arrangement has a first nozzle group 40 having a plurality of nozzles that essentially correspond to the first nozzle group of FIG. 5. The nozzle arrangement is furthermore provided with second and third nozzle groups 44, 48 having a plurality of nozzles, and in particular essentially in correspondence to the second and third nozzle groups 44, 48 of FIG. 5. With the embodiment illustrated in FIG. 6, however, the nozzle groups 44, 48 each have seven instead of five nozzles. Furthermore, the nozzles of the second and third nozzle groups 44, 48 are not disposed on a common straight line; rather, the nozzles are disposed on two parallel straight lines that are offset relative to one another. This offset arrangement also enables the disposition of a plurality of nozzles along the respective straight lines. In this case, the nozzles of the nozzle groups 44, 48 each have a different distance relative to the axis of rotation A. Along a spacing or distance line, proceeding from the axis of rotation A, the nozzles of the second and third nozzle groups 44, 48 respectively alternate. This is furthermore also applicable relative to the first nozzle group 40.

The nozzle arrangement again has a central nozzle 52. The manner of operation of the nozzle arrangement of FIG. 6 corresponds essentially to the manner of operation of the nozzle arrangement of FIG. 5.

FIG. 8 shows a further inventive nozzle arrangement. With the description of FIG. 8, the same reference numerals as in FIG. 5 or 6 are used to the extent that the same or similar elements are indicated.

A semiconductor wafer 3 is disposed below the nozzle arrangement and is rotatable about an axis of rotation A, via a device that is not illustrated in greater detail, as indicated by the arrow B. The nozzle arrangement has a first nozzle group 60 as well as a second nozzle group 62, which are disposed along a straight line that extends through the axis of rotation A. As with the second and third nozzle groups of FIG. 5, the respective nozzles of the nozzle groups 60, 62 alternate along the straight line X-X. In the same way as the second and third nozzle groups 44, 48 of FIG. 5, the nozzle groups 60, 62 are supplied with fluid and are controlled. Again, a central nozzle 52 is provided that lies on the axis of rotation A. Thus, the nozzle arrangement of FIG. 8 is essentially the same as the nozzle arrangement of FIG. 5, although the first nozzle group 40 of FIG. 5 is eliminated.

FIG. 8B shows a section through a nozzle 64 of the first nozzle group 60 along the line X-X in FIG. 8A. As can be seen from the sectional view, the nozzle is inclined relative to the axis of rotation A, and in particular in such a way that a fluid stream exiting the nozzle 64 is directed away from the axis of rotation A. This further enhances the displacement of a fluid disposed upon the substrate 3 since the stream 66 is directed in the displacement direction. Furthermore, the nozzle 64 can also be inclined along the line Y-Y in FIG. 8A in order to provide a tangential component of the nozzle stream or spray relative to the region on the substrate 3 that is concentric to the axis of rotation A. Such an inclination of the nozzle can be provided for all of the nozzles of the various nozzle groups of all of the embodiments, whereby the inclination can differ between the nozzle groups and/or the individual nozzles. Furthermore, it is possible to make the nozzles movable in such a way that the angle of the nozzles can be varied individually and/or in groups.

With the aid of FIGS. 9A to 9H, the rinsing and drying of a semiconductor wafer will now be described. In FIG. 9, the same reference numerals are used as in the preceding figures to the extent that the same or equivalent elements are described.

FIG. 9A shows a treatment apparatus 70 for semiconductor wafers 3. The apparatus 70 is provided with a housing that forms a treatment chamber 72 and has an upper wall 74, a lower wall 76, as well as side walls 78. The housing is provided with a suitable opening for the introduction of the semiconductor wafer 3; however, this opening is not illustrated in detail. Provided within the chamber 72 is a substrate carrier 1 having a carrier ring 5. Provided on the carrier ring 5, as with the embodiment of FIG. 2, are support elements 8 in order to hold a semiconductor wafer 3 above a plane formed by the carrier ring 5. Provided on the upper wall 74, as well as on the lower wall 76, are respective first and second nozzle groups 80, 82 that are directed into the chamber 72. As with the embodiment of FIG. 8, the nozzle groups are disposed on a common straight line, and the nozzles of the respective nozzle groups alternate. The nozzles of the first nozzle group 80 are provided with the reference numerals 80a to 80f in FIG. 9, since the nozzle group 80 has 6 nozzles. The nozzles of the second nozzle group 82 are designated with the reference numerals 82a to 82f.

For the treatment of the semiconductor wafer 3, it is first rotated via the substrate carrier 1 about a non-indicated central axis. By means of the nozzles 80a and 80b of the first nozzle group 80 a rinsing fluid 88, such as DI water, is conveyed onto the upper and lower sides of the wafer 3. As a consequence of the centrifugal force, a rinsing fluid is flung outwardly over the surfaces of the wafer 3 and thus covers the entire upper and lower sides of the wafer 3, as can be clearly recognized in FIG. 9A.

After a certain rinsing time, as can be seen in FIG. 9B a drawing fluid is applied to the upper and lower sides of the wafer 3, via the central nozzle 52, in the region of the axis of rotation. The drying fluid 90 is, for example, a fluid that reduces the surface tension of the rinsing fluid 88. As a consequence, a central drying of the wafer results. Subsequently, the nozzle 80a of the first nozzle group 80 is deactivated and the nozzle 80c is activated, so that now rinsing fluid is conveyed onto the upper and lower sides of the wafer via the nozzles 80b and 80c, as can be seen in FIG. 9C. Furthermore, by means of the nozzle 82a of the second nozzle group 82 the drying fluid 90 is now conveyed onto the upper and lower sides of the wafer 3 in order to provide a radial spreading of the central drying region. As can be seen in FIGS. 9D to 9F, sequentially respectively the innermost (i.e. disposed the closest to the axis of rotation) nozzle of the first nozzle group 80 is deactivated and a more outwardly disposed nozzle is activated, in order to conduct the rinsing fluid onto the upper and lower sides of the wafer 3. In a comparable manner, respectively a nozzle of the second nozzle group 82 that is disposed further from the axis of rotation is used to conduct a drying fluid 90 to the upper and lower sides of the wafer 3 in order to provide a radially expanding drying region. With the view of FIG. 9F, rinsing fluid 88 is applied to the upper and lower sides of the wafer 3 via the two outermost nozzles 80e and 80f of the first nozzle group 80. If the nozzle 80e is now deactivated, no additional nozzle can be activated, so that the rinsing fluid 88 is conducted onto the wafer 3 exclusively via the outermost nozzle 80f, as can be seen in FIG. 9G. As can be furthermore seen in FIG. 9G, drying fluid is conducted onto the wafer 3 subsequently via the nozzles 82e of the second nozzle group 82 that are disposed inwardly relative to the nozzle 80f after the last nozzle 80f of the first nozzle group 80 is deactivated, drying fluid is conducted onto the wafer 3 via the outermost nozzle 82f, as can be seen in FIG. 9H. This ensures a complete drying of the wafer, even in the edge region of the wafer. FIG. 9 shows the apparatus 70 after termination of the drying of the wafer 3. The wafer 3 is entirely dried. All of the nozzles are in a deactivated state, and the wafer 3 can now be removed via a non-illustrated handling device.

The switching or control sequence of the individual modules of the apparatus 70 between the views of FIG. 9C and FIG. 9D will be explained in the following with the aid of FIGS. 10a to 10d. FIG. 10A corresponds to FIG. 9C, while FIG. 10D corresponds to FIG. 9D. FIGS. 10B and 10C represent intermediate steps. As can be seen in FIG. 10A, rinsing fluid 88 is applied to the upper and lower sides of a rotating wafer 3 via the nozzles 80B and 80C. Drying fluid is applied to the wafer 3 via the nozzle 82A. All of the other nozzles are in a deactivated state.

As the next step, as shown in FIG. 10B, the nozzle 80d of the first nozzle group 80 is activated. Thus, rinsing fluid 88 is now conducted onto the wafer 3 via the nozzles 80b, 80c and 80d. Drying fluid is conducted onto the wafer 3 via the nozzle 82a. Subsequently, as shown in FIG. 10C, the nozzle 80b is deactivated, so that the rinsing fluid is conducted onto the wafer 3 only via the nozzles 80c and 80d. Drying fluid is conducted onto the wafer 3 via the nozzle 82a in order initially to achieve a drying radially beyond the application region of the nozzle 82b. Subsequently, the nozzle 82a is closed and the nozzle 82b is opened in order to obtain the drying situation shown in FIG. 10D. As a result of the illustrated switching sequence, a uniform drying is achieved from the middle of the substrate toward the outside. It is to be understood, of course, that every other suitable switching sequence could also be utilized. Instead of the use of a rinsing fluid 88, it is, of course, also possible to use a further treatment fluid or a drying fluid.

The invention was previously described with the aid of preferred embodiments, without being limited to the concretely illustrated embodiments. In particular, different numbers of nozzles are conceivable within the respective nozzle groups. It is also not necessary that the nozzles of the respective nozzle groups be disposed along a straight line. If the nozzles of the respective nozzle groups are disposed along straight lines, it is not necessary that they be disposed upon common or parallel straight lines. Rather, the straight lines of the respective nozzle groups can intersect at any desired angle. It is to be understood, of course, that the inventive apparatus need not be limited to the treatment of semiconductor wafers. Rather, any desired disc-shaped substrates, such as, for example, masks for the manufacture of semiconductor wafers, etc., can be treated in the inventive apparatus. Pursuant to the invention, a single nozzle group can suffice for the inventive treatment apparatus, whereby the individual nozzles of the nozzle group can be supplied with the same and/or different fluids. Instead of a central nozzle that is separate from the nozzle groups, a nozzle of one or more of the nozzle groups that is directed toward the turning center of the substrate can also be provided. Various features of the alternative nozzle arrangements can be combined with one another to the extent that they are compatible. The nozzle arrangements can, in particular, be advantageously used with the rotatable substrate carrier.

1-43. (canceled)

44. An apparatus for treating disc-shaped substrates, comprising:
a device 10 for rotating said substrates 3 about an axis of rotation A; and
at least one first group of nozzles, 40, 60, 80, wherein the nozzles of said first group are differently spaced relative to said axis of rotation A, and wherein said nozzles are adapted to be controlled individually or in sub groups.

45. An apparatus according to claim 44, which comprises at least one further group of nozzles 44, 48; 62; 82, wherein the nozzles of said second group are differently spaced relative to said axis of rotation A.

46. An apparatus according to claim 45, wherein said nozzles of said second group are adapted to be controlled individually or in sub groups.

47. An apparatus according to claim 45, wherein three groups of nozzles 40, 44, 48 are provided.

48. An apparatus according to claim 45, wherein nozzles of at least one further group of nozzles 44, 48; 62; 82 are, with regard to their spacing relative to said axis of rotation A, offset relative to said nozzles of said at least one first group of nozzles 40, 60, 80.

49. An apparatus according to claim 45, wherein nozzles of at least one group of nozzles 40, 44, 48; 60, 62; 80 are disposed along a straight line that extends radially relative to said axis of rotation A.

50. An apparatus according to claim 49, wherein said nozzles of at least two groups of nozzles 44, 48; 60, 62; 80, 82 are disposed along a common straight line.

51. An apparatus according to claim 50, wherein said nozzles of one group of nozzles 44, 48; 60, 62; 80, 82 are disposed between said nozzles of another group of nozzles 48, 44; 62, 60; 82, 80.

52. An apparatus according to claim 45, wherein said nozzles of at least one group of nozzles 40, 44, 48; 60, 62; 80, 82 are adapted to be supplied with fluid via a common fluid supply unit.

53. An apparatus according to claim 52, wherein said nozzles of at least one group of nozzles 40, 44, 48; 60, 62; 80, 82 are adapted to be supplied with fluid via a common pressure line.

54. An apparatus according to claim 45, wherein said nozzles of at least one group of nozzles 40, 44, 48; 60, 62; 80, 82 are adapted to be supplied with different fluids.

55. An apparatus according to claim 45, wherein said nozzles of at least one group of nozzles are adapted to be activated and deactivated individually or in sub groups.

56. An apparatus according to claim 45, wherein at least one of a shape of a nozzle jet or stream, and a flow volume, of at least one nozzle of at least one group of nozzles 40, 44, 48, 60, 62, 80, 82 is adapted to be varied.

57. An apparatus according to claim 45, wherein a nozzle 52 is disposed on or in the vicinity of said axis of rotation A.

58. An apparatus according to claim 57, wherein said nozzle 52 is adapted to be supplied with different fluids.

59. An apparatus according to claim 58, wherein at least two separate feed lines are provided for different fluids.

60. An apparatus according to claim 45, wherein respectively at least one group of nozzles 40, 44, 48; 60, 62; 80, 82 is provided above and below a substrate.

61. An apparatus according to claim 44, which further comprises an essentially planar carrier ring, a rotation device for rotating said carrier ring in the plane thereof about said axis of rotation A, and at least three support elements 8, which extend out of said plane of said carrier ring 5, wherein said support elements 8 form a multi-point support for a substrate 3 at a distance from said carrier ring.

62. A method of treating disc-shaped substrates, including the steps of:
rotating said substrates 3 about an axis of rotation A that is disposed essentially perpendicular to a plane of said substrates;
providing at least one first group of nozzles 40, 60, 80, the nozzles of which are differently spaced relative to said axis of rotation A;
applying a first fluid to said substrates via said at least one first group of nozzles; and
controlling said nozzles of said first group individually or in sub groups to achieve a selective treatment of surface regions of a substrate 3.

63. A method according to claim 62, wherein to terminate treatment with said first fluid, at least one further fluid is conducted onto said substrate via at least one nozzle.

64. A method according to claim 63, wherein said further fluid is conducted onto said substrate via at least one nozzle of a further group of nozzles.

65. A method according to claim 63, wherein said further fluid is applied by a nozzle that is disposed closer to said axis of rotation than is a nozzle via which said first fluid is applied to said substrate in order to displace said first fluid outwardly.

66. A method according to claim 63, wherein nozzles that apply said first fluid are deactivated sequentially in a direction away from said axis of rotation, or are switched over to an application of said second fluid.

67. A method according to claim 64, wherein nozzles that apply said further fluid are activated sequentially in a direction away from said axis of rotation.

68. A method according to claim 63, wherein said further fluid is initially applied to said substrate in a vicinity of said axis of rotation.

69. A method according to claim 63, wherein treatment with said further fluid is terminated by applying a yet further fluid in the same manner as is the treatment with said first fluid.

70. A method according to claim 62, wherein said first fluid is a treatment liquid, a cleaning liquid, or a rinsing liquid.

71. A method according to claim 63, wherein said one further fluid is a rinsing liquid.

72. A method according to claim 63, wherein at least one further fluid is a fluid that reduces a surface tension of fluid found on said substrate.

73. A method according to claim 62, wherein an upper side and a lower side of said substrate are simultaneously treated.

74. An apparatus for treating disc-shaped substrates, comprising:
an essentially planar carrier ring;
a rotation device for rotating said carrier ring in the plane thereof about an axis of rotation; and
at least three support elements, which extend out of said plane of said carrier ring, wherein said support elements form a multi-point support for a substrate at a distance from said plane of said carrier ring.

75. An apparatus according to claim 74, wherein said support elements are provided with support surfaces that are disposed along a peripheral contour of said substrate.

76. An apparatus according to claim 74, wherein said support elements extend into a region of a central opening of said carrier ring.

77. An apparatus according to claim 74, wherein said support elements extend from an inner periphery of said carrier ring.

78. An apparatus according to claim 74, wherein said support elements extend at an incline relative to said plane of said carrier ring.

79. An apparatus according to claim 74, wherein support surfaces of said support elements are inclined relative to said plane of said carrier ring.

80. An apparatus according to claim 74, wherein at least two stop surfaces are provided that extend essentially perpendicular to said plane of said carrier ring and that serve for limiting a lateral movement of said substrate.

81. An apparatus according to claim 80, wherein said stop surfaces are formed on said support elements.

82. An apparatus according to claim 80, wherein said stop surfaces are provided on stop elements that are separate from said support elements.

83. An apparatus according to claim 82, wherein said stop elements are movably disposed on said carrier ring and are movable between a free position and a position where they contact said substrate.

84. An apparatus according to claim 82, wherein said stop elements are movable into contact with said substrate by means of a rotational movement of said carrier ring.

85. An apparatus according to claim 80, wherein said stop elements have a cross-sectional configuration that widens in an essentially V-shaped manner in a direction away from said stop surfaces.

86. An apparatus according to claim 74, wherein said carrier ring, and said rotation device that is associated therewith, are disposed below support surfaces of said support elements.
